(19) United States
(12) Patent Application Publication
(10) Pub. No.: US 2008/0255823 A1
(43) Pub. Date: Oct. 16, 2008

(54) System of Automated Creation of a Software Interface

(75) Inventor: Mark Grant, Le Bar Sur Loup (FR)

Correspondence Address: AKERMAN SENTERFITT, P.O. BOX 3188, WEST PALM BEACH, FL, 33402-3188, US

(73) Assignee: Continental Automotive France, Toulouse (FR)

(21) Appl. No.: 12/062,880

(22) Filed: Apr. 4, 2008

(30) Foreign Application Priority Data
Apr. 10, 2007 (FR) 0702615

(51) Int. Cl. G06F 9/455

(52) U.S. Cl. 703/23

(57) ABSTRACT

A system of automated creation of a software interface between an operator and electronic device functional cores arranged in a target platform. The system includes a designing module comprising a designing window, wherein there are arranged interface visual elements corresponding to control members of the platform and a state machine wherein elements are functionally connected; a validation module for testing whether data issued from the designing module match the properties of the functional cores; and a simulation module of the target platform comprising a translation unit converting data issued from the validation module and transmitting them to a managing member of the target platform in order to simulate said functional cores by means of the control members.

### CROSS REFERENCE TO RELATED APPLICATIONS

This application claims priority to French Patent Application Number 0702615 filed Apr. 10, 2007, the entirely of which is incorporated herein by reference.

### FIELD OF THE INVENTION

This invention relates to the field of communications, and more particularly, to communications between an individual and electronic devices in a vehicle.

### BACKGROUND

Conventionally, for communicating with an electronic device, such as a CD player, a user handles the player control members, such as buttons, or a knurled wheel or a cursor, in order to start playing a CD or to change a track.

However, the multiplication of electronic devices in conveying vehicles, and more particularly in automobiles, requires limiting the number of control members on the dashboard. Indeed, the surface of the dashboard being restricted, it is not possible to arrange thereon control members of each of such devices.

For communicating with a large number of electronic devices despite a restricted number of control members, it is necessary to achieve a software interface between the members and functional cores of the devices which are arranged in a platform. For making things clear and explaining what a core means, the functional core of a CD player could comprise, for example, a playing lens, a laser head and a mechanism for rotating the CD. Through the software interface, control members could be used for controlling several functional cores.

Achieving a software interface is a long and demanding process comprising a large number of steps.

Conventionally, such a process comprises a theoretical “prototyping” step involving schematizing on a tracing paper, using various and colored forms (discs, rectangles, etc.), the control members required for controlling the functional cores of the devices. By way of an example, for an auto-radio comprising a radio receiver, a rectangle, representing a display area, and a colored disc, representing a button, are defined on tracing paper.

The prototyping step is accompanied by a step involving drafting specifications allowing for the relationships to be defined between the control members and the device functional cores. Thus, referring back to the previous example, it is provided, in the specifications, that when the button is activated, the radio receiver is activated and transmits the name of the captured station as well as the title of the song to the display area. Such specifications make it possible to define the requirements of the software Interface.

In a coding step, specifications are translated into a language to be interpreted by the various device functional cores.

Generally speaking, electronic devices are able to interpret a so-called “low-level” language enhancing the performing rate and the error checking, such a coding type being conventionally used in any on-board systems. Such a language is contrasted with the so-called “high-level” language used for achieving prototypes enhancing the graphics.

The coding step is based on the specification document and is specifically implemented for each of the functional cores. This is why, still referring to the previous example, it is required to carry out an individualized coding for an auto-radio having a Hertz radio receiver and an auto-radio having a satellite radio receiver. The generated code is transmitted to a management module located in the vehicle, the management module autonomously administrating the communication between the control members and the functional cores.

Creating the software interface is completed with a practical simulation step where communication between the control members and the functional cores is tested by a user handling said members.

Such a conventional process for creating an interface Involves a large number of disadvantages.

During the coding step, it may happen that the specification document is not strictly respected for technical reasons, so that functions or representation modes are then unable to be coded.

In addition, it is common that the graphics of tracing papers being previously approved when specifications were drafted is not longer suitable. It is then necessary to redefine a prototype, to modify the specifications and to code again the software interface. Repeating previous designing steps results in an extension of the designing cycle.

Additionally, material modifications of functional cores could occur while the interface is being designed. Thus, some functions are removed or added although specifications have been approved, creating the software interface having then to be reinitiated.

Creating a software interface, so-called Human Machine interface (HMI), is a fastidious and long process. Its lack of flexibility requires repeating designing steps without, however, any guarantee for a successful communication between the control members and the functional cores.

### SUMMARY OF THE INVENTION

The invention of the present application aims at overcoming such disadvantages. To this end, it relates to a system for an automated creation of a software interface between an operator and electronic device functional cores being arranged in a target platform. Such a system can comprise:

a designing module comprising a designing window, wherein interface visual elements corresponding to control members of the platform, and a state machine wherein the interface visual, elements are functionally connected;
a validation module for testing whether data issued from the designing module match the properties of the functional cores; and
a simulation module of the target platform comprising a translation unit converting data coming from the validation module and transmitting them to a management member of the platform in order to simulate said functional cores by means of the control members.

The system advantageously allows for the creation cycle of an interface to be shortened while providing for some designing flexibility. The creation system is of the multi-purpose type and could be adapted to any type of devices.

Preferably, the system comprises a simulation module for a software device platform arranged for simulating data from the validation module without being connected to functional cores of the electronic devices.

Thus, the interface is able to be tested without depending on physical devices, thereby avoiding slowing down of the interface, creation when such devices are unavailable.

Still preferably, the interface is simulated by means of a computer connected to the simulation module of a software device platform.

Still preferably, data from electronic device functional cores are displayed on a computer monitor.

Preferably, the interface visual elements have attributes corresponding to the properties of electronic device functional, cores.

This advantageously allows for the application to be Implemented on the target platform without fearing any incompatibilities between the visual elements and the functional cores.

Still preferably, the state machine comprises blocks representing the different interface possible states, the blocks being connected by links representing transition means between the various states.

Yet still preferably, the translation unit of the target simulation module can be parameterized depending on the electronic device functional cores.

### BRIEF DESCRIPTION OF THE DRAWINGS

This invention will be better understood with the following description and the appended drawing on which:

FIG. 1 represents a diagram of the interface creation system according to the present invention;

FIG. 2 represents a diagram of the designing window according to the present invention;

FIG. 3 represents a state diagram according to the present invention; and

FIG. 4 represents another embodiment of the system of this invention with a simulation module of a software device platform.

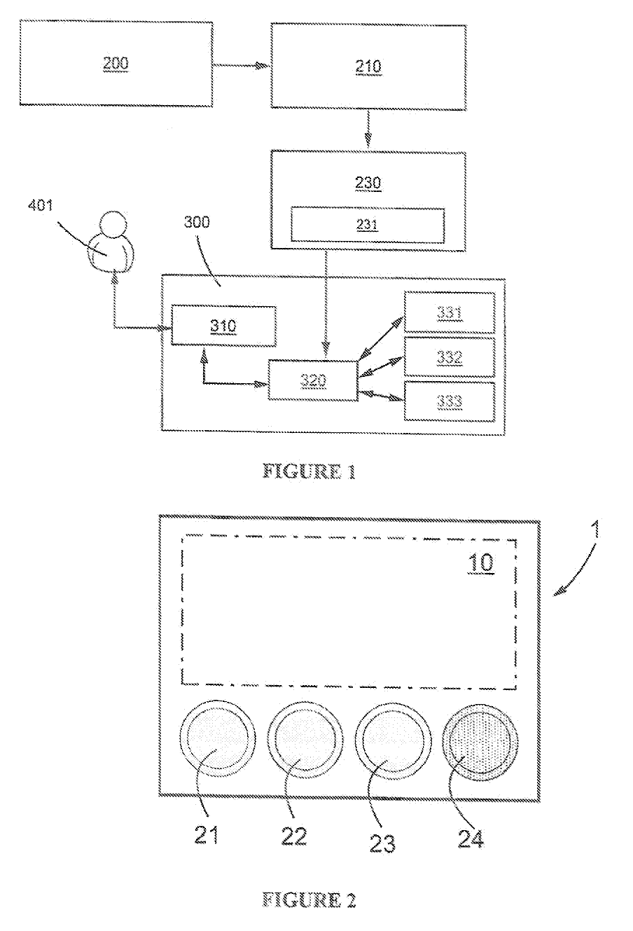

### DETAILED DESCRIPTION

An automobile can comprise several leisure electronic devices (CD/DVD player, radio receiver) and/or electronic devices used for a purpose directly related to driving (GPS receiver, radar detector). In the case of an automobile only comprising a radio receiver, control members of the radio receiver could be used for controlling the receiver, the control members, comprising push or rotary buttons as well as movable cursors.

When a vehicle comprises several of such devices, it is then not possible to arrange on the dashboard of the automobile the control members for all devices.

The various devices with the respective control members thereof are then replaced by a leisure platform gathering the functional cores of the various devices, the functional core of a CD player for example comprising a playing lens, a laser head and a mechanism for driving the CD into rotation. For communicating with a large number of electronic devices despite the limited number of control members, it is necessary to implement a software interface between the members and the device functional cores.

Before explaining the automated creating system of such a software interface, the various constituent modules will be detailed referring, by way of an example, to a multimedia leisure platform 300 for an automobile, comprising the functional cores of a radio receiver 331, a CD player 332 and a GPS unit 333.

The target platform 300 further comprises control members 310 such as push buttons, rotary buttons as well as a liquid crystal display screen (LCD) (not shown). The platform 300 also comprises a management member 320 that could he an on-board calculator, in order to process the various controls received by a user 401 via the control members 310, the control members being transferred to the cores 331, 332, 333 by the member 320.

The interlace creation system comprises a designing module 200, explained herein, allowing for the control members 310 to be theoretically put in communication with the functional cores 331, 332, 333. The designing module 200 is connected with a validation module 210 arranged for checking whether the data supplied to the designing module 200 are consistent with the properties of the functional cores 331, 332, 333. For example, the validation module 210 makes it possible to check whether the screen size shows dimensions compatible with a video output of the GPS unit 333.

The data as issued from the validation module 210 are then transferred to a simulation module for the target platform 230 comprising a translation unit 231 converting data into a language able to be interpreted by the management member 320. The software interface of the platform 300 could then be autonomously simulated via the control members 310. In such an exemplary embodiment, the modules 200, 210, 230 are gathered in a computer(not shown) or the like.

Referring to FIG. 2, the designing module 200 comprises a designing window 1. In such a window 1 are represented graphical forms such as colored discs—representing push buttons 21, 22, 23 and a rotary button 24—and a rectangle representing a liquid crystal screen (LCD) 10 for displaying various graphical characters, such as text, pictures or videos. Such graphical forms are referred to as interface visual elements 10, 21, 22, 23, 24.

Such interface visual elements 10, 21, 22, 23, 24 possess functional attributes corresponding to the functional properties of the cores of the units to be interfaced. By way of an example, the rectangle 10 here has, as an attribute, the screen resolution, the number of colors able to be displayed and the updating frequency. Similarly, the attributes for a rotary button are the number of pitches in rotation and the degree of the no-return force. Thus, for two leisure platforms of the same range, the first one having a LCD (Liquid Crystal Display) type display screen and the second a TFT (Thin-Film Transistor) type display screen, the same designing window 1 could be used with the same interface visual elements, only the attributes thereof being different.

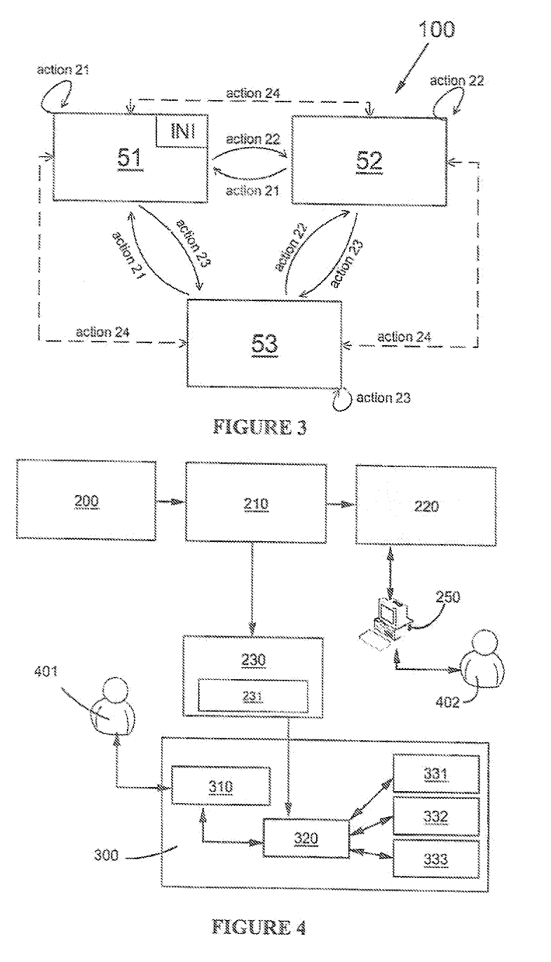

Referring to FIG. 3, the designing module 200 further comprises a diagram or state machine 100, making it possible to define logical, sequential and functional behaviors of interface visual elements 10, 21, 22, 23, 24 arranged in the designing window 1. The machine 100 represents the state of the various interface visual elements 10, 21, 22, 23, 24 upon their actuation.

The interface visual elements 21, 22, 23 respectively activate the core of the radio receiver 331, the core of the audio CD player 332 and the core of the GPS unit 333, the rotary button 24 allowing for switching between the various functional cores.

The state machine 100 has the form of a set of blocks 51, 52, 53 representing the various interface states, the blocks 51, 52, 53 being connected with each other by links corresponding to transitions between states.

The initial state, upon the interface activation, is indicated on the state machine 100 and is marked by the INI abbreviation in the state block 51.

The state blocks 51, 52 and 53 here respectively correspond to the active state of the cores of the radio receiver 331, the audio CD player 332 and the GPS unit 333.

In the initial state, radio is activated. If some action is exerted on the element 22, corresponding to the CD player, the radio is inactivated while the audio CD player is activated. the system being then in the state as represented by the block 52. Similarly, the procedure proceeds to the state as represented by the block 53 while activating the button 23, the GPS unit being then activated. Thus, the buttons 21, 22 and 23 advantageously allow for switching between the various functions of the platform 300.

Similarly, when the state of the system is represented by the block 51 (radio state), activating the button 21 (radio button) does not result in any state modification.

The rotary button 24 is used for switching between the different functions of the platform 300. When the state of the system is represented by the block 5.1, it is sufficient to drive the button 24 into rotation to the left for switching to the GPS function (state 53) and to the right for switching to the CD function (state 52). The dashed arrows on FIG. 3 represent the transitions between the various states upon a rotation of the rotary button 24.

All those actions result In modifications of the display screen 10, such as the display of the name of the radio station, of the artist and of the song, as well as for the receiving frequency.

When an interface visual element 10, 21, 22, 23, 24 is arranged in the designing window 1, such an element could be arranged simultaneously in the state diagram 100, thereby allowing for all attributes of the elements to be accessed rapidly,

Data being added in the designing module 200, both in the designing window 1 and in the state diagram 100, are transmitted to the validation module 210 for checking,

The validation module 210 makes it possible to ensure that the logical sequence of events as defined in the state machine 100, as well as the visual elements 22, 23,24 as defined in the designing window 1, are entered with a suitable format and are consistent with the properties of the functional cores of the units 331, 332, 333.

Such an automated validation step could occur at any time during the interface designing. For example, it is possible to validate the interface after the insertion of each button 21, 22 and 23 into the designing window 1. Such a partial validation allows for any error risk to be prevented and thereby for the interface quality to be enhanced. It thus results from this a time saving on the whole creation process of the interface.

Once the data from the designing module 200 are validated by the module 210, the data are transmitted to a simulation module of the target platform 230, so-called target simulation module, for simulating the interface by means of the control members 310.

The software language used in the designing module 200 is different from that used in the managing member 320 of the platform 300. Thus, for performing a real simulation, a translation unit 231 for the target simulation module 230 allows for designing data to be converted into a so-called “target” low-level language able to be interpreted by the management member 320 of the platform 300. Such a translation is automatically performed, resulting in some time saving.

Moreover, the translation unit 231 could be parameterized as a function of the functional cores 331, 332, 333 it comprises. Thus, for a leisure platform range for an automobile, it is sufficient to modify parameterizing the translation unit 231 in order to adapt the code being generated to the various platforms of the range.

During the real test, a user 401 could actuate control members 310, observe the behavior of functional cores and detect defects typical of the implementation on the target platform 300.

In another embodiment of this invention, it could happen that the platform 300 or the functional cores 331, 332, 333 are unavailable or that it is desired to perform tests with any dependence neither on the physical platform 300 nor on the control members 310. In such an hypothesis, referring to FIG. 4, data from the designing module 200 are transmitted to a simulation module for a software device platform 220, the so-called software simulation module 220 220, simulating the interface created by means of a computer 250 or the like connected with the module 220.

An operator 402, in principle the same operator 401, tests the interface using the software simulation module 220 by clicking with a computer mouse on the button 22 for activating the audio CD player, thereby triggering the display of the “CD” text in the rectangle 10 of the designing window 100 displayed on the computer 250 monitor.

Thus, the operator, who could be a designer or a customer, can appreciate the quality of the interface without, however, depending on the platform 300. This is why, even if the cores of the platform 300 are missing, it is always possible to develop the interface. Moreover, such a “theoretical” interface has been validated by the validation module 220 ensuring the future compatibility of the interface with the platform 300 and the unavailable cores.

As used herein, the terms buttons, knurled wheels, cursors or other handles, also encompass all means for actuating device functions such as sound (for example, vocal) commands, visual commands (detection of the user's movements), touch commands (touch screens), as wed as all the so-called “wireless” commands (infrared, bluetooth, WiFi, radio wave, etc).

1. A system of automated creation of a software interface between an operator and electronic device functional cores arranged in a target platform, the system comprising:
a designing module comprising a designing window, wherein there are arranged interface visual elements corresponding to control members of the platform and a state machine wherein interface visual elements are functionally connected;
a validation module for testing whether data issued from the designing module match the properties of the functional cores; and
a simulation module of the target platform comprising a translation unit converting data issued from the validation module and transmitting them to a managing member of the target platform in order to simulate said functional cores by means of the control members.

2. A system of automated creation of a software interface according to claim 1, comprising a simulation module of a software device platform arranged for simulating data as issued from the validation module without being connected with the electronic device functional cores.

3. A system of automated creation of a software interface according to claim 2, wherein the interlace is simulated by means of a computer connected with the simulation module of a software device platform.

4. A system of automated creation of a software Interface according to claim 3, wherein data issued from the electronic device functional cores are displayed on a computer monitor.

5. A system of automated creation of a software interface according to claim 1, wherein the interface visual elements have attributes corresponding to the properties of the electronic device functional cores.

6. A system of automated creation of a software interface according to claim 1, wherein the state machine comprises blocks representing the various possible states of the interface, the blocks being connected by links representing transition means between the various states.

7. A system of automated creation of a software interface according to claim 1, wherein the translation unit could be parameterized depending on the electronic device functional cores.

8. A system of automated creation of a software interface according to claim 2, wherein the interface visual elements have attributes corresponding to the properties of the electronic device functional cores.

9. A system of automated creation of a software interface according to claim 3, wherein the interface visual elements have attributes corresponding to the properties of the electronic device functional cores.

10. A system of automated creation of a software interface according to claim 4, wherein the interface visual elements have attributes corresponding to the properties of the electronic device functional cores.
